(19) United States
(12) Patent Application Publication
(10) Pub. No.: US 2010/0079723 A1
(43) Pub. Date: Apr. 1, 2010

(54) Toric Ophthalimc Lenses Having Selected Spherical Aberration Characteristics

(76) Inventors: Amanda C. Kingston, Rochester, NY (US); Griffith E. Altmann, Pittsford, NY (US)

Correspondence Address: Bausch & Lomb Incorporated, One Bausch & Lomb Place, Rochester, NY, 14604-2701, US

(21) Appl. No.: 12/243,343

(22) Filed: Oct. 1, 2008

(51) Int. Cl. G02C 7/02

(52) U.S. Cl. 351/176

(57) ABSTRACT

A toric ophthalmic lens having substantially zero spherical aberration for a first circular aperture having a first diameter and substantially zero spherical aberration for a second circular aperture having a second diameter, the first diameter being at least 4 mm and the second diameter being at least 3 mm, the first diameter being at least 0.5 mm larger than the second diameter. A series of ophthalmic lenses, each lens comprising a same spherical power as the other lenses in the set, and a unique cylindrical power, each lens comprising (i) a first toric surface, and (ii) a second surface, at least one of the first surface and the second surface being aspheric in a meridian, the lens having substantially zero spherical aberration for all circular optical zone diameters less than 4 mm.

### FIELD OF INVENTION

The present invention relates to toric ophthalmic lenses, and more particularly to toric ophthalmic lenses having selected spherical aberration characteristics.

### BACKGROUND OF THE INVENTION

Ophthalmic lenses having a toric surface in an optical zone (commonly referred to as “toric ophthalmic lenses”) are used to correct refractive abnormalities of the eye associated with astigmatism. For example, such toric lenses may be configured as spectacles, contact lenses, intraocular lenses (IOLs), corneal inlays or corneal onlays.

In such lenses, the optical zone provides cylindrical correction to compensate for astigmatism in the cornea and/or crystalline lens. The optical zone of the lens will have a meridian of highest dioptric power and a meridian of lowest dioptric power. Since astigmatism that requires correction is usually associated with other refractive abnormalities, such as myopia (nearsightedness) or hypermetropia (farsightedness), toric ophthalmic lenses are generally prescribed with a spherical power to correct myopic astigmatism or hypermetropic astigmatism. A toric optical zone may be formed on either a posterior lens surface (to achieve a “back surface toric lens”) or an anterior lens surface (to form a “front surface toric lens”).

Toric ophthalmic lenses are manufactured with a selected orientation of the cylindrical axis of the toric surface as determined by a corresponding stabilization structure (e.g., an eye glasses frame, a contact lens ballast or haptics of an IOL). Said orientation is referred to herein as offset. For example, this relationship may be expressed as a number of degrees that the cylindrical axis is angularly displaced from a vertical axis of the lens. Toric ophthalmic lens prescriptions specify offset, with toric lenses generally being offered in 5 or 10-degree increments ranging from 0 degrees to 180 degrees.

In summary, to define an optical correction, a prescription for a toric ophthalmic lens will typically specify a spherical power, a cylindrical correction and offset. In addition, an ophthalmic lens prescription may specify an overall lens diameter as well as various other fitting parameters. For example, in the case of contact lenses, a base curve may also be specified.

### SUMMARY

Toric ophthalmic lenses like all ophthalmic lenses can be characterized by an amount of spherical aberration. Unlike spherically symmetric lenses, toric ophthalmic lenses may have spherical aberration characteristics along a first meridian that are different than the spherical aberration characteristics along a second meridian.

As set forth in commonly assigned U.S. patent application Ser. No. 11/057,278, filed Feb. 11, 2005 by Altmann, it is desirable that a spherically symmetric (e.g., non-toric) lens have no inherent spherical aberration. In other words, a plane wavefront (e.g., coming from an object at an optically infinite distance) will be refracted by the lens to a sharp focal point in an image plane. A lens having no spherical aberration is advantageous in that an amount of misalignment or decentering of the lens from the visual axis, which typically happens to a lens in an ocular system, will not give rise to asymmetric aberrations such as coma or astigmatism.

Aspects of the present invention are directed to achieving zero spherical aberration in toric (i.e., rotationally asymmetric) ophthalmic lenses. Other aspects of the present invention apply the Applicant's discovery that, even though spherical aberration may be equal to zero or substantially zero for a given aperture (e.g., a 5 mm diameter circular aperture) of a toric ophthalmic lens, the spherical aberration for a smaller aperture (e.g., a 3 mm diameter circular aperture) of the same lens may not be zero. Accordingly, toric ophthalmic lenses according to aspects of the present invention have zero spherical aberration for a first, relatively large aperture and zero spherical aberration for a second, relatively small aperture.

An aspect of the invention is directed to a toric ophthalmic lens having substantially zero spherical aberration for a first circular aperture having a first diameter and substantially zero spherical aberration for a second circular aperture having a second diameter, the first diameter being at least 4 mm and the second diameter being at least 3 mm, the first diameter being at least 0.5 mm larger than the second diameter.

In some embodiments, the substantially zero spherical aberration for the first aperture and the second aperture is achieved for 546 nm light. In some embodiments, the first diameter is at least 4.5 mm and the second diameter being at least 3.5 mm. In some embodiments, the first aperture and the second aperture both have spherical aberration magnitudes that are less than 1/10 of wave (i.e., in the range of positive 1/10 of a wave to negative 1/10 of a wave).

In some embodiments, the lens has a posterior optical zone and an anterior optical zone, at least one of the posterior optical zone and the anterior optical zone is toric, the toric optical zone being biaspheric. In some embodiments, at least one meridian of the toric optical zone comprises even-powered aspheric terms. The at least one meridian of the toric optical zone may comprise only even-powered aspheric terms.

In some embodiments, the lens is an intraocular lens. In some embodiments, the lens is a contact lens.

Another aspect of the invention is directed to an ophthalmic lens, comprising a first toric surface, and a second surface, at least one of the first surface and the second surface being aspheric in a meridian, the lens having substantially zero spherical aberration for all circular optical zone diameters less than 4 mm.

In some embodiments, the substantially zero spherical aberration is achieved for 546 nm light. In some embodiments, the lens has substantially zero spherical aberration for all circular optical zone diameters less than 4.5 mm. In some embodiments, the lens has substantially zero spherical aberration for all circular optical zone diameters less than 5.0 mm. In some embodiments, the spherical aberration has a magnitude of less than 1/20 of wave for all circular optical zone diameters less than 4 mm.

In some embodiments, the aspheric meridian is a meridian of a toric surface. In some embodiments, the aspheric meridian is a meridian of a circularly symmetric surface.

In some embodiments, the toric surface is biaspheric.

In some embodiments, at least one meridian of the toric surface comprises even-powered aspheric terms. In some embodiments, the toric surface comprises only even-powered aspheric terms.

In some embodiments, the lens is an intraocular lens. In some embodiments, the lens is a contact lens.

Yet another aspect of the invention is directed to a series of ophthalmic lenses, each lens comprising a same spherical power as the other lenses in the set, and a unique cylindrical power. Each lens in the series comprises (i) a first toric surface, and (ii) a second surface. At least one of the first surface and the second surface is aspheric in a meridian, such that the lens has substantially zero spherical aberration for all circular optical zone diameters less than 4 mm. The lenses in the series may be configured like any of lenses described above.

Dimensions described herein refer to dimensions of a finished lens. For example, the lenses are fully cured and/or the lenses are fully hydrated.

In contact lens embodiments, the term “effective base curvature” is defined herein to mean the average radius of curvature of the posterior surface calculated over the entire posterior surface of a lens optic, including the periphery.

As used herein the term “substantially zero spherical aberration” means in the range between positive one-tenth of a wave and negative one-tenth of a wavelength (i.e., a magnitude of one tenth of wave) in the visible band. It will be appreciated that it is typically advantageous that substantially zero aberration occur for light at 546 nm, the approximate wavelength at which a human eye has its highest sensitivity. However, substantially zero spherical aberration may be achieved for any suitable wavelength in the visible band (400-700 nm) or for the entire visible band.

### BRIEF DESCRIPTION OF THE DRAWINGS

Illustrative, non-limiting embodiments of the present invention will be described by way of example with reference to the accompanying drawings, in which the same reference number is used to designate the same or similar components in different figures, and in which:

FIG. 1A is a plan view of a lens according to aspects of the present invention;

FIG. 1B is a schematic cross section of the lens of FIG. 1A taken along line 1B-1B;

FIG. 1C is a second schematic cross section of the lens of FIG. 1A taken along line 1C-1C; and

FIG. 2 is a schematic cross of an example of a contact lens embodiment of a lens according to aspects of the present invention.

### DETAILED DESCRIPTION

As stated above, aspects of the present invention apply the applicants' discovery that, even though spherical aberration may be equal to zero or substantially zero for a given aperture (e.g., a 5 mm circular aperture) of a toric ophthahnic lens, the spherical aberration for a smaller aperture (e.g., a 3 mm circular aperture) of the same lens may not be zero. This unexpected occurrence arises due to the relatively complex shape of a toric lens. Toric ophthalmic lenses according to aspects of the present invention have an aspheric surface selected to provide zero spherical aberration for a first relatively large aperture and zero spherical aberration for a relatively small aperture.

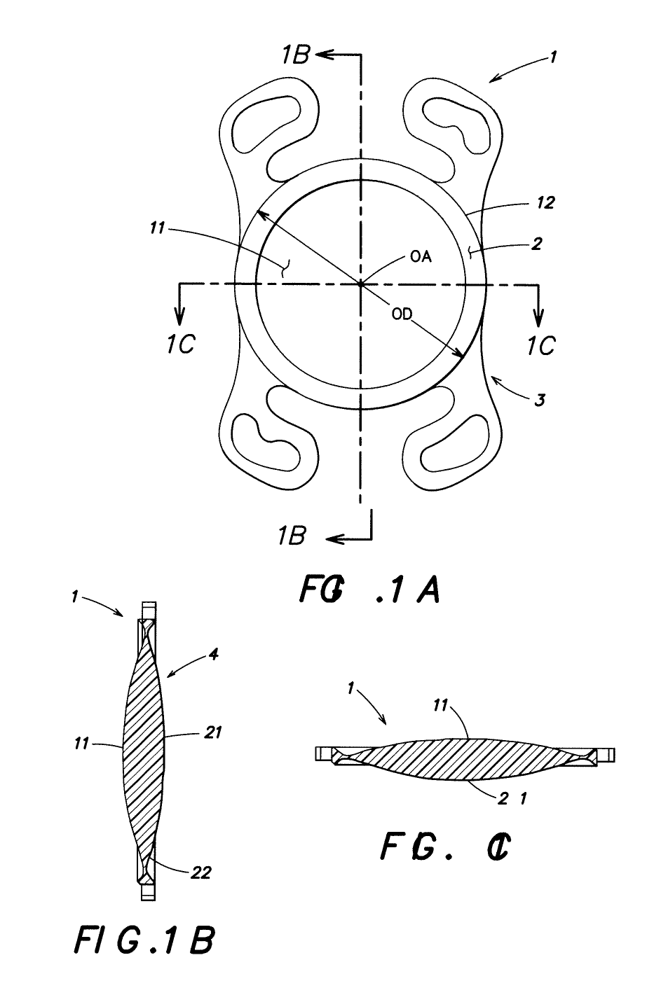

FIGS. 1A-1C are schematic illustrations of an example embodiment of a toric ophthalmic lens 1 according to aspects of the present invention. In the illustrated embodiment, a posterior central zone 11 (also referred to herein as a posterior optical zone) of posterior surface 3 is toric. The posterior central zone is the portion of the posterior surface that is optically corrected. Posterior surface 3 includes a peripheral zone 12 surrounding the central zone 11. In some embodiments, a blend zone is present between the central zone 11 and the peripheral zone 12. A blend zone is a non-optically corrected region that provides a more gradual transition from the central zone 11 to the peripheral zone 12 than would occur if the central zone were immediately adjacent to peripheral zone 12.

As illustrated in FIG. 1B, a central zone 21 of an anterior surface 4 of toric ophthalmic lens 1 has a spherical power. Anterior surface 4 includes at least one peripheral curve 22 surrounding central zone 21. Central zone 21, in combination with central zone 11, is adapted to produce an image that is suitably corrected for vision.

In the illustrated embodiment, central zone 11 of posterior surface 3 of toric ophthalmic lens 1 is biaspheric. That is, the surface is constructed such that aspheric terms are present in each of a meridian of highest dioptric power and a meridian of lowest dioptric power of the toric surface. The aspheric terms are blended together in regions between the meridians to form a smooth surface using a conventional technique. According to aspects of the present invention, the lens has substantially zero spherical aberration for all optical zone diameters of less than 4 mm. Such optical zones are typically, but not necessarily, centered about an optical axis OA.

In some instances, confirmation that a suitable spherical aberration has been achieved for all diameters can be had by measuring spherical aberration for circular apertures (centered about an optical axis of the lens), the apertures having diameters between a maximum diameter and a minimum diameter. For example, for a lens having a maximum diameter of 5 mm, confirmation that a suitable spherical aberration has been achieved for all diameters can be had by measuring spherical aberration for a 5 mm diameter circular aperture, a 4 mm diameter circular aperture and a 3 mm diameter circular aperture, and confirming that a substantially zero spherical aberration has been achieved for each. Confirmation of suitable spherical aberration performance can be had during design of the lens using design software and/or, after manufacture, using metrology techniques. In some instances, for such a lens, confirmation that a suitable spherical aberration has been achieved for all diameters can be had by measuring spherical aberration for a 5 mm diameter circular aperture, a 4.5 mm diameter circular aperture, a 4 mm diameter circular aperture, a 3.5 mm diameter circular aperture, and a 3 mm diameter circular aperture, and confirming that a substantially zero spherical aberration has been achieved for each aperture. Under typical circumstances, for aperture diameters of less than 3 mm, a lens is practically operating in a paraxial regime and spherical aberration is negligible.

Typically, a lens is specified to have substantially zero spherical aberration for light at 546 nanometers (nm) (i.e., approximately a wavelength of maximum sensitivity for photopic conditions). However, lenses may be designed for wavelengths or bandwidths at any suitable wavelength within the visible band (i.e., approximately 400-800 nm). It is typically advantageous that spherical aberration be in a range between positive one-tenth of a wave (of the selected wavelength) and negative one-tenth of a wave. In some embodiments, the spherical aberration is in a range between positive one-fifteenth of a wave and negative one-fifteenth of a wave, or in a range between positive one-twenty fifth of a wave and negative one-twenty fifth of a wave.

For example, a biaspheric surface may be selected to be biconic (i.e., a conic term as shown in Equation 1 is selected for each of the highest dioptric power and lowest dioptric power meridians). Alternatively, the biaspheric surface can be selected to comprise a conic and even aspheric terms, as shown in Equation 2, or any other suitable aspheric configuration (e.g., only even aspheric terms).

$${z}_{conic} ( r ) = \frac{{cr}^{2}}{1 + \sqrt{1 - ( 1 + k ) {c}^{2} {r}^{2}}} \qquad Equation 1$$

where z_{conic} is the sag of a conic surface; c is the curvature of said surface; k the conic constant; and r a radial coordinate. If k=0, then the surface would be spherical.

z(r)=z_{conic}(r)+α₁r²+α₂r⁴+α₃r⁶+α₄r⁸+α₅r¹⁰ Equation 2

where each αₙ is a coefficient term corresponding to a given polynomial term.

It will be appreciated that Equation 2 includes a conic term and even-powered polynomial terms. It will also be appreciated that z (r) (i.e., sag) in each of Equations 1 and 2 will vary as a function of x and y for a toric surface. In embodiments of the present invention that include even aspheric terms, at least one of the αₙ terms is non-zero. It will be understood that it is typically desirable that the number of αₙ terms selected to be non-zero be the minimum necessary to achieve a selected performance and the magnitude of each αₙ be as small as possible. By so controlling the number and magnitude of said terms, sensitivity to decentration may be reduced, and manufacturability and testing of lenses may be simplified.

It will also be appreciated that, in some embodiments, the lenses include surfaces having only even-powered aspheric terms. It is further to be appreciated that although even-powered polynomial terms may be all that are necessary to achieve selected aberration performance for a lens, in some embodiments, odd-powered polynomial terms may be added. For example, odd-powered aspheric terms may be appropriately used with contact lens embodiments, where decentration is likely.

In the illustrated embodiment, posterior surface 3 is a biaspheric, toric surface and is combined with an underlying spherical shape such that the surface provides an appropriate spherical optical power. The curvature of anterior central zone 21 is selected such that anterior central zone 21, in combination with posterior central zone 11, provides a desired spherical power of the lens.

In the illustrated embodiment, the lens is configured with a biaspheric surface on the posterior surface (i.e., on the toric surface) to achieve substantially zero spherical aberration for all optical zone diameters less than 5 mm; and the anterior surface is spherical. In other embodiments in which a toric surface is located on the posterior surface, a biaspheric surface may be located only on the anterior surface. It will be appreciated that if the biaspheric surface is placed only on a surface opposite toric surface, the lens will have two non-spherical surfaces. In some embodiments, such a configuration may be undesirable due, for example, to manufacturing complications associated with having two complex surfaces.

It is to be appreciated that although the illustrated lens has a posterior surface that is toric, according to aspects of the present invention, the anterior and/or posterior surfaces may be toric.

In some embodiments, both a toric surface and a non-toric surface have aspheric components. In some embodiments, a non-toric surface can be selected to provide substantially zero spherical aberration in one meridian, and an aspheric term can be provided on the other meridian on the toric surface, such that the surfaces combine to achieve substantially zero spherical aberration in, both, a meridian of highest dioptric power and a meridian of lowest dioptric power. In some embodiments, an aspheric component is provided in only a first meridian of a non-toric surface and the second meridian of the toric surface is spherical. In such embodiments, the combination of the asphere and the curvature of the spherical surface achieve substantially zero spherical aberration for suitable optical zone diameters in the first meridian; and the combination of the spherical curvature in the second meridian of the toric surface and the curvature of the spherical surface in the second meridian achieve substantially zero spherical aberration for all suitable optical zone diameters in the second meridian

Additional aspects of the lens according to aspects of the present invention are directed to toric ophthalmic lenses characterized by substantially zero spherical aberration for a first aperture having a first diameter and substantially zero spherical aberration for a second aperture having a second diameter. According to such aspects, the first diameter is at least 4 mm, and the second diameter is at least 3 mm. Also according to such aspects, the first diameter is at least 0.5 mm larger than the second diameter. In some embodiment, the first diameter is at least 4.5 mm, and the second diameter is at least 3.5 mm. In such embodiments, the first diameter is at least 0.5 mm larger than the second diameter. In some embodiments, the first diameter is at least 5 mm, and the second diameter is at least 4 mm. In such embodiments, the first diameter is at least 0.5 mm larger than the second diameter.

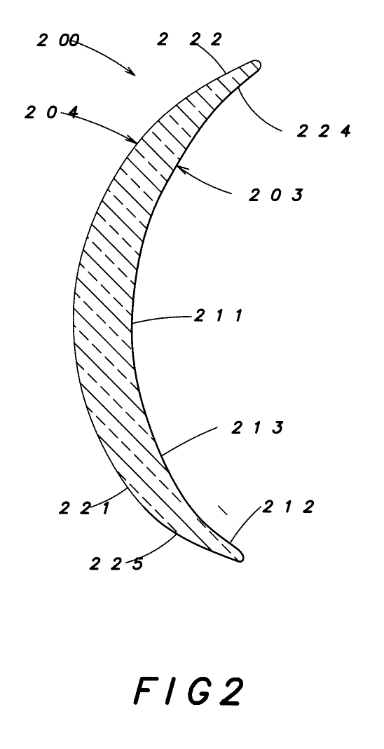

FIG. 2 schematically illustrates an example of an embodiment of a toric contact lens 200 according to aspects of the present invention. In the illustrated embodiment, central zone 211 (also referred to herein as the posterior optical zone) of posterior surface 203 is toric, i.e., this zone has a surface that provides a desired cylindrical correction, and may include spherical power. Posterior surface 203 includes a peripheral zone 212 surrounding the central toric zone 211.

In contact lens embodiments, the peripheral surface, including the peripheral zone, is configured to fit on a surface of the eye. A blend zone 213 may be disposed between the peripheral zone 212 and central toric zone 211. The blend zone is a non-optically corrected region that provides a more gradual transition from the central toric zone 211 to the peripheral zone 212 than would occur if the central toric zone were immediately adjacent to peripheral zone 212. Such a blend zone may be added to improve comfort for a wearer.

A central zone 221 of an anterior surface 204 of lens 200 is spherical. The curvature of central zone 221 is selected such that central zone 221, in combination with central zone 211, provides a desired spherical power of the lens. Anterior surface 204 includes at least one peripheral curve 222 surrounding central zone 221. It is to be appreciated that although the illustrated lens has a posterior surface that is toric, as described above, according to aspects of the present invention, the anterior and/or posterior surfaces may be toric. Also as described above, one or more aspheric terms may be added to the anterior and/or posterior surface to achieve appropriate spherical aberration correction.

Also as described above, toric contact lenses are provided with a stabilization structure so that the lenses maintain a desired rotational orientation on the eye. For example, lens 200 may include a prism ballast 225 wherein peripheral section 224 has a different thickness than an opposed peripheral section including ballast 225 of the lens periphery. (Ballast 225 is at a “bottom” portion of the lens, since, when this type of toric lens is placed on the eye, the prism ballast is located downwardly.) The ballast is oriented about an axis, referred to herein as the “ballast axis.” As discussed above, toric ophthalmic lens prescriptions define an offset of the ballast axis from the cylindrical axis of the toric zone by a selected angle. The term “offset” is inclusive of angles of 0 degrees or 180 degrees, which describe lenses in which the cylindrical axis is coincident with the ballast axis.

Sets of lenses having spherical aberration correction according to aspects of the present invention may be useful. For example, such a set may comprise a series of ophthalmic lenses, each lens comprising a same spherical power as the other lenses in the series, and a unique cylindrical power. Each lens in such a set may comprise (i) a first toric surface, and (ii) a second surface; at least one of the first surface and the second surface is aspheric in a meridian. In some such embodiments, such lenses are configured to have substantially zero spherical aberration for all circular optical zone diameters less than 4 mm.

In other such embodiments of sets, such lenses are configured to have substantially zero spherical aberration for a first circular aperture having a first diameter and substantially zero spherical aberration for a second circular aperture having a second diameter. In such embodiments, the first diameter is at least 4 mm and the second diameter is at least 3 mm, the first diameter being at least 0.5 mm larger than the second diameter.

The following optical prescriptions provide examples of lenses according to aspects of the present invention. Twenty diopter lenses are used in the examples below for purposes of illustration; any suitable dioptric power may be used. All results are computer-calculated using Zemax optical design software, version Jan. 22, 2007. Zemax design software is available from Zemax Development Corporation of Bellevue, Wash

### EXAMPLE 1

Table 1 illustrates an example of a series of lenses according to aspects of the present invention in which each lens has a spherical power of 20 diopters and each lens has a unique cylindrical power. Cylindrical power of the lenses is provided on the posterior surface. Each surface of a lens has a suitable conic constant for a meridian of highest dioptric power and a suitable conic constant for a meridian of lowest dioptric power. As shown in Table 2, for each lens, for apertures having diameters of 3 mm, 4 mm and 5 mm, respectively, the spherical aberration is equal to substantially zero at 546 nanometers.

TABLE 1

| Spherical | | Anterior | | Posterior | | | | Center |
|---|---|---|---|---|---|---|---|---|
| Equivalent | Cylinder | Radius | | Radius-x | Conic-x | Radius-y | Conic-y | Thickness |
| (D) | (D) | (mm) | Conic | (mm) | (k) | (mm) | (k) | (mm) |
| 20 | 1.25 | 20.756 | 3.390 | −8.359 | −1.588 | −9.133 | −1.824 | 0.792 |
| 20 | 2.00 | 8.150 | −1.834 | −20.100 | 12.256 | −30.000 | 29.404 | 0.789 |
| 20 | 2.75 | 13.363 | 2.520 | −10.052 | −3.511 | −12.963 | −4.826 | 0.775 |
| 20 | 3.50 | 11.196 | −2.798 | −11.345 | −0.345 | −16.764 | 5.067 | 0.766 |
| 20 | 4.25 | 10.778 | −2.499 | −11.387 | 0.988 | −18.790 | 2.327 | 0.835 |

TABLE 2
Spherical Aberration (um)

| 3 mm | 4 mm | 5 mm |
|---|---|---|
| 0.00 | 0.00 | 0.00 |
| 0.00 | 0.00 | 0.00 |
| 0.00 | 0.00 | 0.00 |
| 0.00 | 0.00 | 0.00 |
| 0.00 | 0.00 | 0.00 |

### EXAMPLE 2

Table 3 illustrates an example of a lens according to aspects of the present invention in which the lens has a spherical power of 20 diopters and has a cylindrical power of 2.00 diopters. Cylindrical power is provided on the posterior surface. The anterior surface of the lens has even aspheric terms (α) and suitable conic constant terms (k) for a meridian of highest dioptric power and a meridian of lowest dioptric. As shown in Table 4, for apertures having diameters of 3 mm, 4 mm and 5 mm, respectively, the spherical aberration is equal to substantially zero at 546 nanometers.

TABLE 3

| | Anterior | | | | | Posterior | | | | |
|---|---|---|---|---|---|---|---|---|---|---|
| Spherical | Cylinder | Radius | | | | Radius-x | Conic-x | Radius-y | Conic-y | Center Thickness |
| Equivalent (D) | (D) | (mm) | Conic | α2 | α3 | (mm) | (k) | (mm) | (k) | (mm) |
| 20 | 2.00 | 8.182 | −0.494 | −1.45E−04 | −1.01E−06 | −20.222 | 3.069 | −30.172 | 8.444 | 0.788 |

TABLE 4
Spherical Aberration (um)

| 3 mm | 4 mm | 5 mm |
|---|---|---|
| 0.00 | 0.00 | 0.00 |

### EXAMPLE 3

Table 5 illustrates an example of a series of lenses according to aspects of the present invention in which each lens has a spherical power of 20 diopters and a cylindrical power of 2 diopters. As shown in Table 6, for each lens, for apertures having diameters of 3 mm, 4 mm and 5 mm, respectively, the spherical aberration is equal to substantially zero at 546 nanometers. Tables 5 and 6 show that by selecting an aspheric term (e.g., conic term) for one or more of (i) a circularly symmetric (i.e., non-toric) surface, (ii) the meridian of highest power of a toric surface, and (iii) the meridian of lowest power of a toric surface, a lens can be designed to have suitable spherical aberration performance. In the first lens of Table 5, in addition to a conic term in a non-toric surface, one meridian of the toric surface has a toric term. In the second lens of Table 5, only the non-toric surface has a conic term. In the third lens of Table 5, no conic term is present in a non-toric surface, and both meridians of the toric surface have a toric term. Although the lenses in Table 5 are shown with conic terms as described above, the lenses could have achieved similar spherical aberration performance if even and/or aspheric terms were implemented.

TABLE 5

| Spherical | | Anterior | | Posterior | | | | Center |
|---|---|---|---|---|---|---|---|---|
| Equivalent | Cylinder | Radius | | Radius-x | | Radius-y | | Thickness |
| (D) | (D) | (mm) | Conic | (mm) | Conic-x | (mm) | Conic-y | (mm) |
| 20 | 2.00 | 8.182 | −0.887 | −20.224 | 0.000 | −30.176 | −5.512 | 0.788 |
| 20 | 2.00 | 9.159 | −1.111 | −16.028 | 0.000 | −21.693 | 0.000 | 0.787 |
| 20 | 2.00 | 9.161 | 0.000 | −16.024 | −7.929 | −21.686 | −13.999 | 0.789 |

TABLE 6
Spherical Aberration (um)

| 3 mm | 4 mm | 5 mm |
|---|---|---|
| 0.00 | 0.00 | 0.00 |
| 0.00 | 0.00 | 0.00 |
| 0.00 | 0.00 | 0.00 |

Having thus described the inventive concepts and a number of exemplary embodiments, it will be apparent to those skilled in the art that the invention may be implemented in various ways, and that modifications and improvements will readily occur to such persons. Thus, the embodiments are not intended to be limiting and presented by way of example only. The invention is limited only as required by the following claims and equivalents thereto.

What is claimed is:

1. A toric ophthalmic lens having substantially zero spherical aberration for a first circular aperture having a first diameter and substantially zero spherical aberration for a second circular aperture having a second diameter, the first diameter being at least 4 mm and the second diameter being at least 3 mm, the first diameter being at least 0.5 mm larger than the second diameter.

2. The lens of claim 1, wherein the substantially zero spherical aberration for the first aperture and the second aperture is achieved for 546 nm light.

3. The lens of claim 1, wherein the first diameter is at least 4.5 mm and the second diameter being at least 3.5 mm,

4. The lens of claim 1, wherein the first aperture and the second aperture both have spherical aberration magnitudes that are less than 1/10 of wave.

5. The lens of claim 1, wherein the lens has a posterior optical zone and an anterior optical zone, at least one of the posterior optical zone and the anterior optical zone being toric, the toric optical zone being biaspheric.

6. The lens of claim 1, wherein the lens has a posterior optical zone and an anterior optical zone, at least one of the posterior optical zone and the anterior optical zone being toric, at least one meridian of the toric optical zone comprises even-powered aspheric terms.

7. The lens of claim 6, wherein at least one meridian of the toric optical zone comprises only even-powered aspheric terms.

8. The lens of claim 1, wherein the lens is an intraocular lens.

9. The lens of claim 1, wherein the lens is a contact lens.

10. An ophthalmic lens, comprising:
a first toric surface; and
a second surface, at least one of the first surface and the second surface being aspheric in a meridian, the lens having substantially zero spherical aberration for all circular optical zone diameters less than 4 mm.

11. The lens of claim 10, wherein the substantially zero spherical aberration is achieved for 546 nm light.

12. The lens of claim 10, wherein the lens has substantially zero spherical aberration for all circular optical zone diameters less than 4.5 mm.

13. The lens of claim 10, wherein the lens has substantially zero spherical aberration for all circular optical zone diameters less than 5.0 mm.

14. The lens of claim 10, wherein the spherical aberration has a magnitude of less than 1/20 of wave for all circular optical zone diameters less than 4 mm.

15. The lens of claim 10, wherein the meridian is a meridian of a toric surface.

16. The lens of claim 10, wherein the meridian is a meridian of a circularly symmetric surface.

17. The lens of claim 10, wherein the toric surface is biaspheric.

18. The lens of claim 10, wherein at least one meridian of the toric surface comprises even-powered aspheric terms.

19. The lens of claim 18, wherein the toric surface comprises only even-powered aspheric terms.

20. The lens of claim 10, wherein at least one meridian of the toric surface comprises only odd-powered aspheric terms.

21. The lens of claim 10, wherein the lens is an intraocular lens.

22. The lens of claim 10, wherein the lens is a contact lens.

23. A series of ophthalmic lenses, each lens comprising a same spherical power as the other lenses in the series, and a unique cylindrical power, each lens comprising (i) a first toric surface, and (ii) a second surface, at least one of the first surface and the second surface being aspheric in a meridian, the lens having substantially zero spherical aberration for all circular optical zone diameters less than 4 mm.
